(19) United States
(12) Patent Application Publication
(10) Pub. No.: US 2026/0334715 A1
(43) Pub. Date: Oct. 29, 2026

(54) FILTRATION DEVICE AND BEVERAGE EXTRACTOR

(71) Applicant: THREE RIVERS CO., LTD., Saga (JP)

(72) Inventor: Takashi Mikawa, Saga (JP)

(21) Appl. No.: 19/124,126

(22) PCT Filed: Dec. 12, 2023
(86) PCT No.: PCT/JP2023/044501

§ 371 Date: Apr. 24, 2025

(30) Foreign Application Priority Data
Dec. 28, 2022 (JP) 2022-212714

(51) Int. Cl. A47J 31/06; A47J 31/08; B01D 39/20

(52) U.S. Cl. CPC A47J 31/0636; A47J 31/08; B01D 39/2068; B01D 2201/0415; B01D 2201/306

(57) ABSTRACT

A filtration device comprises: a substantially cylindrical frame formed of an elastic member and detachably attached to an opening of a container in which an extraction object and liquid are accommodated; and a filter part that is disposed in a region enclosed by the frame, that allows flowing out, to the outside, of a beverage extracted from the extraction object in the container, that is composed of porous ceramic for preventing flowing out of the extraction object, and that can be attached to and detached from the frame. The frame has: an annular large-diameter portion at which the filter part is disposed; and a small-diameter portion which has a diameter smaller than that of the large-diameter portion and which is a portion to be inserted in the opening of the container in the case of attaching the frame to the container. The small-diameter portion has a flange-shaped attachment portion which extends outward in a radial direction thereof and which can be folded toward the large-diameter portion side.

### TECHNICAL FIELD

The present invention relates to a filtration device and a beverage extractor.

### BACKGROUND ART

Conventionally, devices for extracting beverages such as coffee and tea are known. For example, Patent Document 1 discloses a device including a container for receiving tea leaves and a liquid, and a concave filter that engages with the edge of the container and has a plurality of openings that prevent the tea leaves from flowing out and allow the tea extract to flow out.

### CITATION LIST

### Patent Document

Patent Document 1: Japanese Unexamined Patent Application, Publication No. 2008-246187

### DISCLOSURE OF THE INVENTION

### Problems to be Solved by the Invention

Although the device of Patent Document 1 can provide a beverage extracted from tea leaves by placing tea leaves and hot water in the container and engaging and attaching the concave filter to the edge of the container, the dimensions and shape of the filter must be accurately matched to the dimensions and shape of the container to prevent the filter from falling off from the container when pouring the beverage.

An object of the present invention is to provide a filtration device and a beverage extractor capable of extracting and pouring a beverage more easily.

### Means for Solving the Problems

The present invention relates to a filtration device including a frame part detachably attached to an opening of a container configured to contain an extraction material and a liquid, the frame part being formed by an elastic member; and a porous filter part disposed in a region surrounded by the frame part and configured to allow a beverage extracted from the extraction material in the container to flow out to an outside and prevent the extraction material from flowing out.

The frame part has a substantially cylindrical shape, and includes a flange-shaped attachment part that extends radially outward.

The filter part is made of porous ceramic.

The filter part is attachable to and detachable from the frame part.

The filter part has a substantially circular shape in plan view in a state where the frame part is attached to the container. The filter part includes a pouring part tapered radially outward, and an opening formed on a side opposite to the pouring part.

The present invention relates to a beverage extractor including the filtration device, and the container configured to contain the extraction material and the liquid and having the opening to which the filtration device can be attached.

### Effects of the Invention

According to the present invention, a beverage can be extracted and poured more easily.

### BRIEF DESCRIPTION OF THE DRAWINGS

FIG. 1 is a perspective view showing a beverage extractor according to an embodiment of the present invention;

FIG. 2 is a side view showing a filtration device according to the embodiment of the present invention;

FIG. 3 is a plan view showing the filtration device according to the embodiment of the present invention;

FIG. 4 is a bottom view showing the filtration device according to the embodiment of the present invention;

FIG. 5 is a cross-sectional view of the beverage container shown in FIG. 3 taken along line V-V;

FIG. 6 is an exploded perspective view showing the filtration device according to the embodiment of the present invention;

FIG. 7 is a plan view showing a filter part of the filtration device according to the embodiment of the present invention;

FIG. 8 is a bottom view showing the filter part of the filtration device according to the embodiment of the present invention;

FIG. 9 is a plan view showing a frame part of the filtration device according to the embodiment of the present invention;

FIG. 10 is a cross-sectional view showing a beverage extractor in which an extraction material and a liquid are contained in the container; and

FIG. 11 is a schematic view showing a state in which a beverage extracted from the extraction material using a beverage extractor is poured into a beverage container.

### PREFERRED MODE FOR CARRYING OUT THE INVENTION

Hereinafter, an embodiment of the present invention will be described. However, the present invention is not limited to the following embodiment.

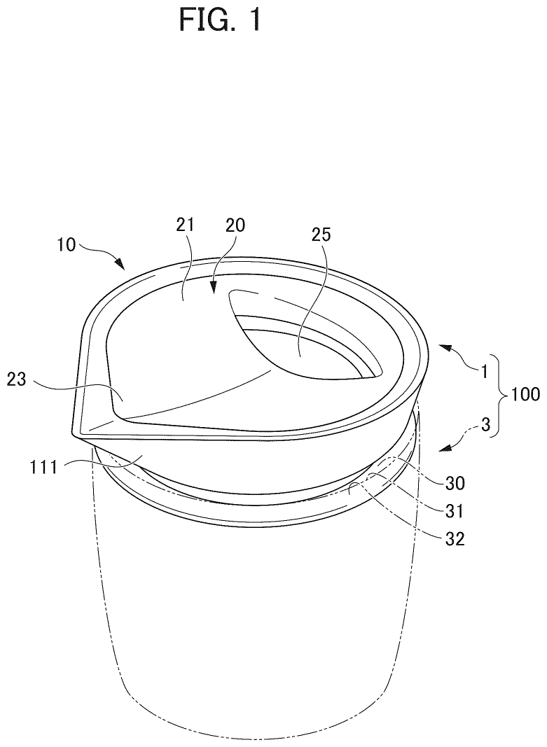

A filtration device 1 according to the present embodiment will be described with reference to FIG. 1. FIG. 1 is a perspective view of a beverage extractor 100. In FIG. 1, a container 3 is indicated by a two-dot chain line.

The filtration device 1 of the present embodiment is a device that is attached to the container 3 that contains an extraction material and a liquid and is used for pouring a beverage extracted in the container 3 into a beverage container or the like. Examples of the extraction material include coffee beans and tea leaves. Examples of the beverage include coffee extracted from coffee beans and tea extracted from tea leaves.

The container 3 has, for example, a bottomed cylindrical shape, and contains the extraction material and the liquid.

Examples of the liquid include hot water as an extraction solvent for coffee beans and tea leaves. The filtration device 1 is attached to an opening 30 of the container 3. The filtration device 1 and the container 3 to which the filtration device 1 is attached constitute a beverage extractor 100 that extracts a beverage from an extraction material and pours the extracted beverage into a beverage container or the like.

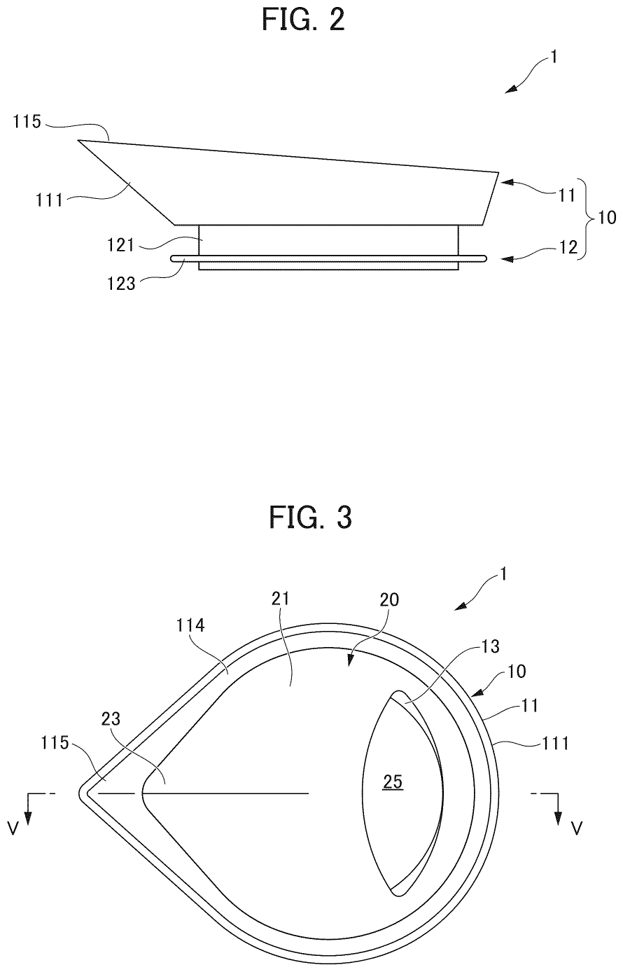

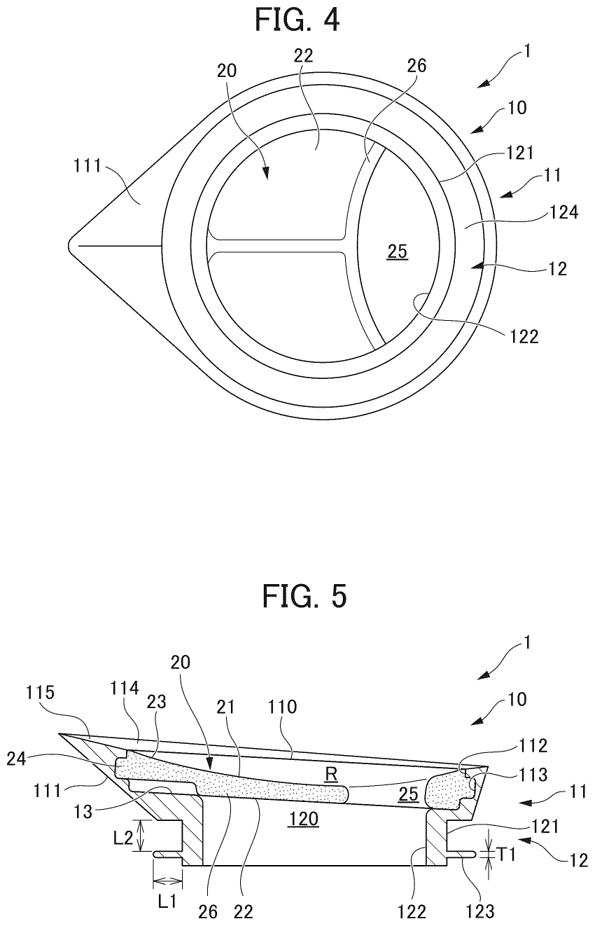

The configuration of the filtration device 1 will be described with reference to FIGS. 1 to 9. FIG. 2 is a side view of the filtration device 1. FIG. 3 is a plan view of the filtration device 1. FIG. 4 is a bottom view of the filtration device 1. FIG. 5 is a cross-sectional view of the filtration device 1 shown in FIG. 3 taken along line V-V.

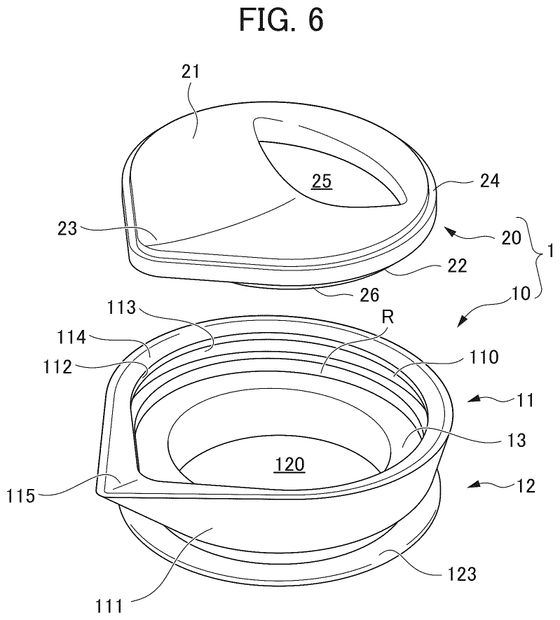

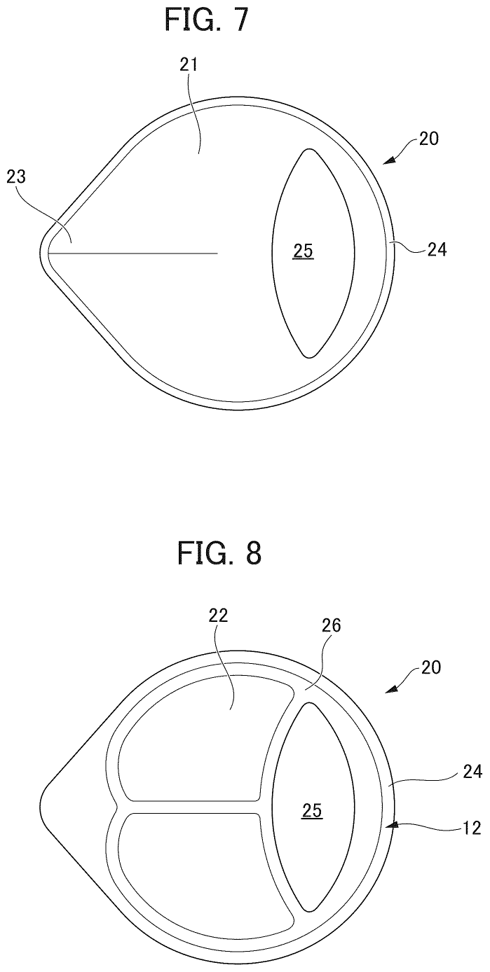

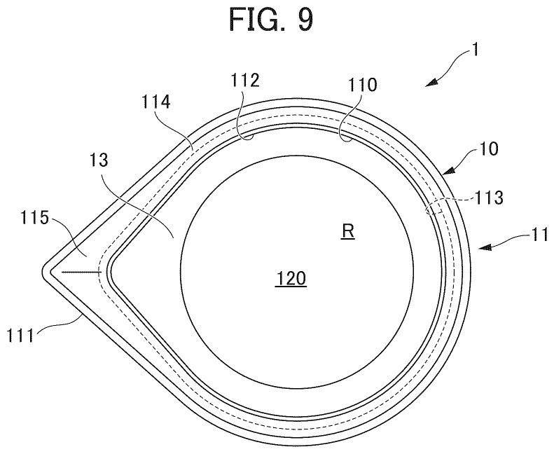

FIG. 6 is an exploded perspective view of the filtration device 1. FIG. 7 is a plan view of a filter part 20. FIG. 8 is a bottom view of the filer part 20. FIG. 9 is a plan view of a frame part 10.

As shown in FIG. 1, the filtration device 1 includes the frame part 10 attached to the container 3 and the filter part 20 for filtering a beverage. In the following description, the up-down direction along the vertical direction in the state where the filtration device 1 is attached to the container 3 is referred to as the up-down direction of the filtration device 1.

The frame part 10 is detachably attached to the opening 30 of the container 3 and a part in which the filter part 20 is disposed. The frame part 10 is formed by an elastic member and is elastically deformable as a whole. Examples of the elastic member forming the frame part 10 include natural rubber and synthetic rubber. The elastic member forming the frame part 10 of the present embodiment is silicon rubber.

As shown in FIGS. 5 and 6, the frame part 10 is cylindrical and includes a large diameter part 11, a small diameter part 12 having a diameter smaller than that of the large diameter part 11, and a coupling part 13 coupling the large diameter part 11 and the small diameter part 12. The large diameter part 11 is located above the small diameter part 12 in a state where the frame part 10 is attached to the container 3. The coupling part 13 is located between the large diameter part 11 and the small diameter part 12.

The large diameter part 11 will be described. As shown in FIGS. 5, 6, and 9, the large diameter part 11 has an annular shape as a whole, and its outer peripheral surface 111 is tapered, increasing in diameter in a direction away from the coupling part 13. As shown in FIG. 9, an opening 110 of the large diameter part 11 has a shape in which a part of the edge protrudes radially outward in plan view. A fitting groove part 113 into which the filter part 20 is fitted and a tapered surface 114 are formed on the inner peripheral surface 112 of the large diameter part 11.

As shown in FIGS. 5, 6, and 9, the fitting groove part 113 is an annular groove formed on the entire circumference of the inner peripheral surface 112 of the large diameter part 11.

The fitting groove part 113 is fitted into a fitting protruding part 24 (described later) of the filter part 20.

That is, the filter part 20 is disposed in the region R surrounded by the inner peripheral surface 112 in which the fitting groove part 113 is formed.

The tapered surface 114 is formed on the upper end side of the inner peripheral surface 112 of the large diameter part 11 (opposite to the coupling part 13 in the axial direction of the frame part 10). The tapered surface 114 forms the upper surface of the filtration device 1 in a state where the frame part 10 is attached to the container 3. The tapered surface 114 is tapered, increasing in diameter in a direction away from the small diameter part 12.

The tapered surface 114 is formed with a pouring part 115 whose width decreases toward the outer side in the radial direction in plan view. That is, the pouring part 115 has a shape tapered outward in the radial direction of the large diameter part 11. The outer peripheral surface 111 of the part where the pouring part 115 is formed is formed so as to protrude radially outward when viewed from below. This feature allows the beverage flowing out from the inside of the container 3 through the filter part 20 to be smoothly guided to the outside.

The small diameter part 12 will be described. The small diameter part 12 is a part to be inserted into the opening 30 of the container 3 when the frame part 10 is attached to the container 3. The small diameter part 12 is formed in an annular shape whose diameter is smaller than that of the large diameter part 11.

The inner diameter and the outer diameter of the small diameter part 12 are substantially constant in the axial direction of the frame part 10. That is, the outer peripheral surface 121 and the inner peripheral surface 122 of the small diameter part 12 are substantially parallel to the axial direction of the frame part 10. The dimensions of the opening 120 of the small diameter part 12 is smaller than the dimensions of the opening 110 of the large diameter part 11 and the dimensions of the filter part 20.

The small diameter part 12 has a flange-shaped attachment part 123 extending from the outer peripheral surface 121 thereof to the outside in the radial direction of the frame part 10. The attachment part 123 is elastically in close contact with the inner peripheral surface 32 of the container 3 in a state where the frame part 10 is attached to the container 3.

The length L1 of the attachment part 123 in the radial direction of the frame part 10 is preferably equal to or less than the interval L2 from the surface of the attachment part 123 on the coupling part 13 side to the surface of the coupling part 13 on the small diameter part 12 side in the axial direction of the frame part 10. In the present embodiment, the length L1 of the attachment part 123 and the interval L2 are formed to be substantially equal to each other. The length L1 of the attachment part 123 and the thickness T1 of the attachment part 123 (the width of the attachment part 123 in the axial direction of the frame part 10) are adjusted within a range in which the attachment part 123 can be bent. With this configuration, when the filtration device 1 is inserted into the container 3 having the opening 30 larger than the diameter up to the outer peripheral surface 121 of the small diameter part 12, the attachment part 123 is bent toward the large diameter part 11 by the upper end part 31 of the container 3 as the frame part 10 is inserted into the opening 30. In this state, the attachment part 123 is pressed against and in close contact with the inner peripheral surface 32 of the container 3 by its own restoring force directed outward in the radial direction.

The coupling part 13 is formed in an annular shape in plan view in an inner lower part of the large diameter part 11.

The coupling part 13 couples the lower end part of the large diameter part 11 and the upper end part of the small diameter part 12, and is a part on which the filter part 20 is placed. The coupling part 13 has a substantially circular shape in which a part of the circumference protrudes radially outward in plan view.

The filter part 20 has a disk shape as a whole as shown in FIG. 6, and has a substantially circular shape in plan view as shown in FIG. 7. In the present specification, the substantially circular shape refers to a circular shape or a shape close to a circular shape, and includes, for example, an oval, an ellipse, a circular shape in which a part of the circumference protrudes radially outward, and the like. The filter part 20 of the present embodiment has a shape corresponding to the opening 110 of the large diameter part 11 of the frame part 10. That is, the filter part 20 has a substantially circular shape in which a part of the circumference protrudes radially outward in plan view.

The filter part 20 has dimensions and a shape whose contour corresponds to the region R of the large diameter part 11 and is disposed in the region R surrounded by the inner peripheral surface 112 of the frame part 10. The dimensions of the filter part 20 is larger than the dimensions of the opening 120 of the small diameter part 12.

The filter part 20 according to the present embodiment is attachable to and detachable from the frame part 10. Specifically, the filter part 20 is not fixed to the frame part 10, and can be disposed in the region R in the large diameter part 11 by elastically deforming the frame part 10, and can be removed from the region R to the outside of the large diameter part 11.

The filter part 20 includes a porous ceramic filter. The central pore diameter of the micropores of the filter part 20 is preferably 300 μm to 430 μm. The size, porosity, and the like of the micropores of the filter part 20 are set as appropriate according to the type of the extraction material and the type of beverage. In a state where the frame part 10 is attached to the container 3, the filter part 20 allows the beverage extracted from the extraction material in the container 3 to flow out to the outside and prevents the extraction material from flowing out.

The thickness of the filter part 20 is preferably 3 mm to 4 mm from the viewpoint of maintaining the strength of the filter part 20 and smoothly flowing the beverage from the inside to the outside of the container 3.

The filter part 20 includes a curved upper surface 21 slightly curved inward, a bottom surface 22 having an arc shape slightly bulging downward, a pouring part 23, a fitting protruding part 24, an opening 25, and a rib part 26.

The pouring part 23 has a shape tapered outward in the radial direction of the filter part 20. That is, the pouring part 23 is a part in which a part of the circumference protrudes radially outward in plan view of the filter part 20. The pouring part 23 serves as a flow path through which the beverage flowing out from the inside of the container 3 to the outside passes in a state where the filtration device 1 is attached to the container 3.

The fitting protruding part 24 is an annular part protruding radially outward from the peripheral edge of the filter part 20. The fitting protruding part 24 is fitted into the fitting groove part 113 formed in the inner peripheral surface 112 of the frame part 10. The pouring part 23 of the filter part 20 is disposed at a position corresponding to the pouring part 115 of the frame part 10 in a state where the fitting protruding part 24 is fitted into the fitting groove part 113.

The opening 25 is formed on the opposite side to the pouring part 23. Specifically, as shown in FIG. 7, the opening 25 is formed on the opposite side to the pouring part 23 in plan view, with the center of the upper surface 21 located in between, and penetrates from the upper surface 21 to the bottom surface 22. As shown in FIGS. 3 and 5, the opening 25 is formed between the center of the upper surface 21 and the coupling part 13 on the opposite side to the pouring part 115 in plan view in a state where the filter part 20 is disposed in the region R of the frame part 10. Since the opening 25 is formed in the filter part 20, the space in the container 3 communicates with the outside through the opening 120 of the small diameter part 12 and the opening 25. This allows the extraction material and liquid to be added to the container 3 through the opening 25 while the filtration device 1 is attached to the container 3. As shown in FIG. 3, in the opening 120 of the small diameter part 12, the part other than the part where the opening 25 is located in plan view is blocked by the filter part 20.

The rib part 26 is formed so as to protrude downward from the bottom surface 22. The rib part 26 is formed around the opening 25 in the bottom surface 22, near the peripheral edge part of the filter part 20, and the like. In a state where the filter part 20 is disposed in the region R of the large diameter part 11, the rib part 26 formed near the peripheral edge part of the filter part 20 abuts on the coupling part 13.

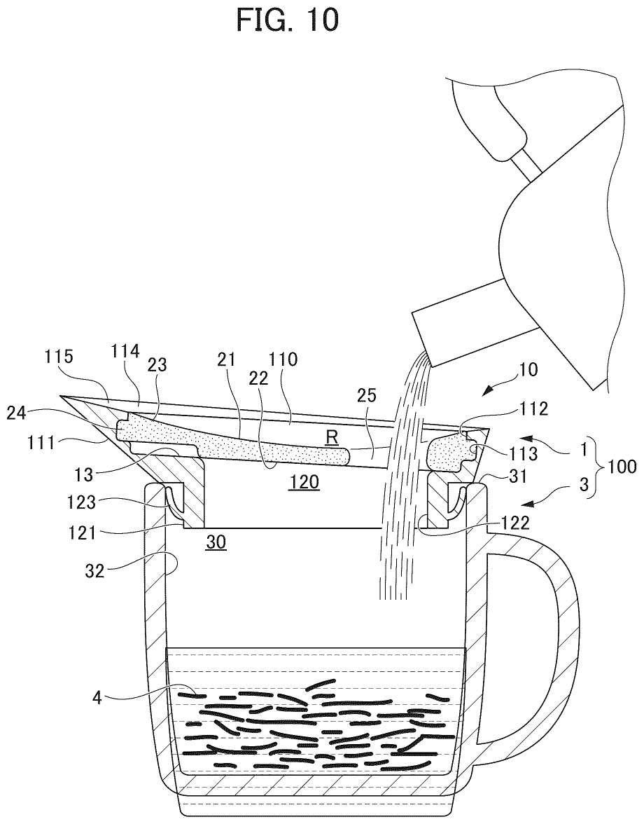

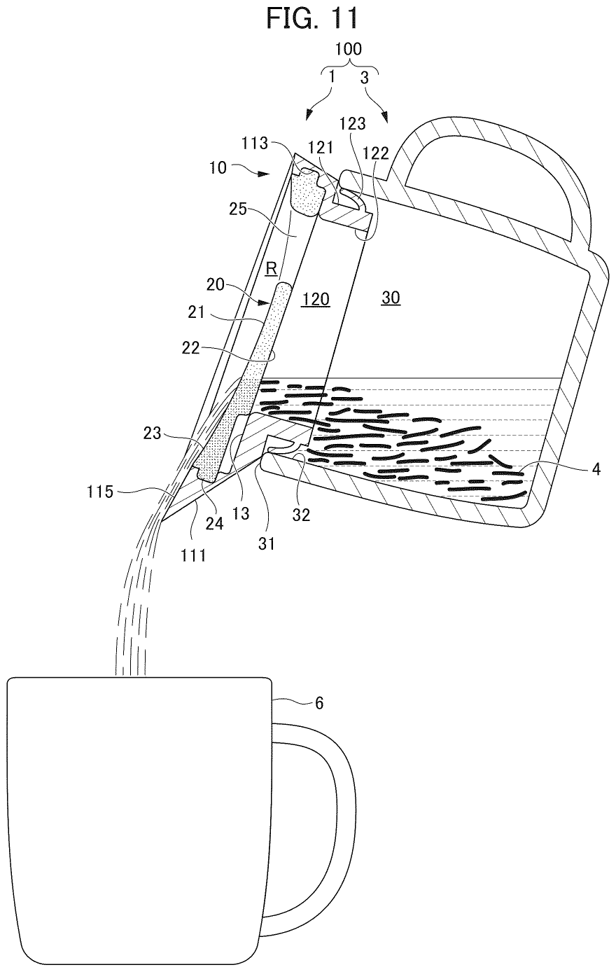

Next, an example of use of the filtration device 1 will be described with reference to FIGS. 10 and 11. FIG. 10 is a cross-sectional view showing a beverage extractor 100 in which tea leaves 4 being an extraction material and a liquid are contained in the container 3. FIG. 11 is a schematic view showing a state in which tea, which is a beverage extracted from the tea leaves 4 using the beverage extractor 100, is poured into a beverage container 6. In FIG. 10 and FIG. 11, a case where the extraction material is tea leaves will be described as an example.

First, the tea leaves 4 and hot water are poured through the opening 30 into the bottomed cylindrical container 3 in a state where the filtration device 1 is not attached. Next, the filtration device 1 in which the filter part 20 is disposed in the region R of the frame part 10 is attached to the container 3 in which the tea leaves 4 and hot water are contained. Specifically, the small diameter part 12 of the filtration device 1 is inserted into the opening 30 of the container 3. At this time, as the small diameter part 12 is inserted into the opening 30, the flange-shaped attachment part 123 of the small diameter part 12 is bent upward (toward the large diameter part 11) by the upper end part 31 and the inner peripheral surface 32 of the container 3. In this state, the attachment part 123 is pressed against and in close contact with the inner peripheral surface 32 of the container 3 by its own restoring force directed outward in the radial direction. The tea leaves 4 and hot water may be introduced into the container 3 through the opening 25 of the filter part 20 after the filtration device 1 is attached to the container 3 as shown in FIG. 10.

After a predetermined period of time has elapsed during which the beverage is extracted from the tea leaves 4, the beverage extractor 100 including the filtration device 1 and the container 3 to which the filtration device 1 is attached is tilted, and the beverage in the container 3 is poured into the beverage container 6. Specifically, as shown in FIG. 11, the beverage is poured into the beverage container 6 by tilting the beverage extractor 100 so that the pouring parts 115 and 23 are located on the lower side in the filtration device 1. At this time, as shown in FIG. 11, the beverage passes through the micropores of the filter part 20 from the inside of the container 3, and is poured into the beverage container 6 through the pouring part 23. On the other hand, the tea leaves 4 cannot pass through the micropores, are blocked by the bottom surface 22 of the filter part 20, and remain in the container 3. This allows only the beverage to be poured from the container 3 into the beverage container 6. Additionally, even when the beverage extractor 100 is tilted, since the attachment part 123 is elastically in close contact with the inner peripheral surface 32 of the container 3 by its own restoring force toward the outer side in the radial direction, it is possible to prevent the filtration device 1 from falling off from the container 3. Further, when the amount of the beverage in the container 3 decreases, since the inside of the container 3 communicates with the outside through the opening 25 of the filter part 20, hot water or tea leaves can be easily added through the opening 25.

According to the filtration device 1 and the beverage extractor 100 of the present embodiment, the following effects are achieved.

(1) The filtration device 1 includes the frame part 10 that is detachably attached to the opening 30 of the container 3 configured to contain an extraction material and a liquid and is formed by an elastic member, and a porous filter part 20 that is disposed in the region R surrounded by the frame part 10 and allows a beverage extracted from the extraction material in the container 3 to flow out to the outside and prevents the extraction material from flowing out.

Accordingly, since the frame part 10 surrounding the filter part 20 having a filtering function is formed by an elastic member having shape followability, the beverage can be poured so that the filter part 20 does not fall off from the container 3 without strictly matching the dimensions and the shape of the filtration device 1 to the opening 30 of the container 3. Additionally, the filtration device 1 can be attached to more containers 3 of different dimensions and shapes to extract and pour beverages. Thus, beverages can be extracted and poured more easily.

(2) The filtration device 1 is configured such that the frame part 10 has a substantially cylindrical shape and includes a flange-shaped attachment part 123 that extends radially outward and is elastically in close contact with the inner peripheral surface 32 of the container 3 on the opening 30 side. Thus, when the beverage in the container 3 is poured into the beverage container 6 or the like by tilting the container 3, it is possible to more reliably prevent the filtration device 1 from falling off from the container 3.

(3) The filter part 20 of the filtration device 1 is made of porous ceramic. This allows the liquid to drip through the micropores of the ceramic, thus making the taste of the liquid mild. For example, when used for extraction of tea and coffee, tea and coffee having more excellent taste and flavor can be easily provided.

(4) The filter part 20 of the filtration device 1 is configured to be attachable to and detachable from the frame part 10. This allows the filter part 20 to be removed from the frame part 10 after being used for extraction of a beverage, making it easier to remove the extraction material adhering to the filter part 20 when cleaning the filtration device 1 and facilitating the cleaning operation.

(5) The filter part 20 of the filtration device 1 has a substantially circular shape in plan view in a state of being disposed in the region R of the frame part 10 attached to the container 3. The filter part 20 includes the pouring part 23 tapered radially outward, and the opening 25 formed on a side opposite to the pouring part 23. This allows the extraction material and the liquid as the extraction solvent to be added through the opening 25 while the filtration device 1 is attached to the container 3, thus improving convenience.

(6) The beverage extractor 100 includes the filtration device 1 and the container 3 configured to contain an extraction material and a liquid and having the opening 30 to which the filtration device 1 can be attached. Accordingly, since the frame part 10 surrounding the filter part 20 having a filtering function is formed by an elastic member having shape followability, the beverage can be poured so that the filter part 20 does not fall off from the container 3 without strictly matching the dimensions and the shape of the filtration device 1 to the opening 30 of the container 3. This allows beverages to be extracted and poured more easily.

Although the embodiment of the present invention has been described above, the present invention is not limited to the above-described embodiment and can be modified as appropriate.

In the above embodiment, the filter part 20 is attachable to and detachable from the frame part 10, but the filter part 20 may be fixed to the frame part 10.

In the above embodiment, the filter part 20 has a substantially circular shape in plan view, but the shape thereof is not limited. For example, the filter part 20 may have a polygonal shape in plan view.

### EXPLANATION OF REFERENCE NUMERALS

1 filtration device
3 container
10 frame part
20 filter part
30 opening
100 beverage extractor
R region

1. A filtration device comprising:
a frame part detachably attached to an opening of a container configured to contain an extraction material and a liquid, the frame part being formed by an elastic member; and
a porous filter part disposed in a region surrounded by the frame part and configured to allow a beverage extracted from the extraction material in the container to flow out to an outside and prevent the extraction material from flowing out,
the frame part comprising
an annular large diameter part in which the filter part is disposed, and
a small diameter part having a diameter smaller than that of the large diameter part and being a part to be inserted into the opening of the container when the frame part is attached to the container,
the small diameter part comprising a flange-shaped attachment part that extends radially outward and can be bent toward the large diameter part.

2. The filtration device according to claim 1, wherein the filter part is made of porous ceramic.

3. The filtration device according to claim 1, wherein the filter part is attachable to and detachable from the frame part.

4. The filtration device according to claim 1,
wherein the filter part has a substantially circular shape in plan view in a state where the frame part is attached to the container, and
wherein the filter part comprises
a pouring part tapered radially outward, and
an opening formed on a side opposite to the pouring part.

5. A beverage extractor comprising:
the filtration device according to claim 1; and
the container configured to contain the extraction material and the liquid and having the opening to which the filtration device can be attached.
